(19) United States
(12) Patent Application Publication
(10) Pub. No.: US 2022/0278599 A1
(43) Pub. Date: Sep. 1, 2022

(54) MULTI-SOLENOID LINEAR VIBRATION MOTOR

(71) Applicant: AAC Microtech (Changzhou) Co., Ltd., Changzhou City (CN)

(72) Inventors: Zhiyong Cui, Shenzhen (CN); Lubin Mao, Shenzhen (CN); Jie Ma, Shenzhen (CN); Ziang Li, Shenzhen (CN); Kejia Liu, Shenzhen (CN)

(21) Appl. No.: 17/566,707

(22) Filed: Dec. 31, 2021

(30) Foreign Application Priority Data
Mar. 1, 2021 (CN) 202120445816.0

(51) Int. Cl. H02K 33/18

(52) U.S. Cl. CPC H02K 33/18

(57) ABSTRACT

The present disclosure provides a multi-solenoid linear vibration motor having a housing body with an accommodation space; a stator including N solenoid assemblies, where N is an integer not less than 2; a vibrator including N+1 pieces of axial magnet units; and an elastic connector. Each solenoid assembly locates between two adjacent axial magnet units. A length of the axial magnet unit is greater than a length of the solenoid assembly. A magnetizing direction of the axial magnet unit is perpendicular to the axial direction of the solenoid assembly. A polarity of the magnetic pole on a side of the central area is opposite to a polarity of the magnetic pole. The adjacent axial magnet units are opposite to each other with the same poles facing each other; energization directions of the adjacent solenoid assemblies are opposite. Driving force is accordingly improved.

### FIELD OF THE PRESENT DISCLOSURE

The present disclosure relates to motors, in particular to a linear vibration motor for providing tactile feedback.

### DESCRIPTION OF RELATED ART

The magnetic circuit of the linear vibration motor in the prior art mostly has a single solenoid assembly structure. The voice coil in a single solenoid assembly has more turns. The iron core is easy to reach magnetic saturation when the current is large, and the driving force of the magnetic circuit is weak.

Therefore, it is necessary to provide a new type of multi-solenoid linear vibration motor.

### SUMMARY OF THE PRESENT DISCLOSURE

One of the objects of the present disclosure is to provide a multi-solenoid linear vibration motor which improves the driving force produced by the magnetic circuit system and reduces effectively the magnetic saturation caused by the iron core at large currents.

To achieve the above-mentioned objects, the present disclosure provides A multi-solenoid linear vibration motor, comprising: a housing body with an accommodation space; a stator installed in the housing body, comprising N solenoid assemblies with parallel axes and spaced apart from each other, where N is an integer not less than 2;

a vibrator comprising N+1 pieces of axial magnet units parallel to an axis of the solenoid assembly, a length of the axial magnet unit is greater than a length of the solenoid assembly; a magnetizing direction of the axial magnet unit is perpendicular to the axis of the solenoid assembly, the axial magnet unit comprises a central area directly opposite to the solenoid assembly and two outer areas respectively located at two ends of the central area, and a polarity of the magnetic pole on a side of the central area close to the solenoid assembly is opposite to a polarity of the magnetic pole on a side of the outer area close to the solenoid assembly; and an elastic connector suspending the vibrator in the housing body; wherein each solenoid assembly locating between two adjacent axial magnet units, each axial magnet unit locating between two adjacent solenoid assembly; the adjacent axial magnet units are opposite to each other with the same poles facing each other; energization directions of the adjacent solenoid assemblies are opposite.

In addition, the axial magnet unit is a monolithic multi-polar magnetized magnet or is formed by a combination of multiple split magnets arranged in parallel.

In addition, an amount of the solenoid assemblies is two; and an amount of the axial magnet units is three.

In addition, the vibrator further includes a pair of end magnet units perpendicular to the axis of the solenoid assembly; the end magnet unit includes N end part areas respectively corresponding to each of the solenoid assemblies; the magnetizing direction of the end magnet unit is parallel to the axis direction of the solenoid assembly; the polarity of the magnetic pole of the central area of the axial magnet unit facing the adjacent solenoid assembly is opposite to that of the end part area of the end magnet unit facing the solenoid assembly; the pair of end magnet units are arranged opposite to each other with the same pole and are respectively arranged at two ends of the solenoid assembly.

In addition, the end magnet unit is an integrated multi-polar magnetized magnet or is formed by a plurality of separate magnets arranged in parallel.

In addition, both ends of the axial magnet unit located between two adjacent solenoid assemblies are respectively fixedly connected to the pair of end magnet units.

In addition, an amount of the solenoid assembly is two; and an amount of the axial magnet units is three.

In addition, the vibrator further includes a weight; the pair of end magnet units is fixedly connected to the weight.

In addition, the vibrator further includes a weight; an outermost axial magnet unit is connected to the inner wall of the weight through a pole plate.

In addition, the elastic connector includes a substrate, two connection parts symmetrically arranged at ends of the substrate, and a fixed connection between one of the connection parts and the weight; the other connection part connects with the inner wall of the housing body; a pair of the elastic connectors is symmetrically arranged on opposite sides of the weight.

### BRIEF DESCRIPTION OF THE DRAWINGS

Many aspects of the exemplary embodiments can be better understood with reference to the following drawings. The components in the drawing are not necessarily drawn to scale, the emphasis instead being placed upon clearly illustrating the principles of the present disclosure.

FIG. 1 is an isometric view of a multi-solenoid linear vibration motor in accordance with a first embodiment of the present disclosure;

FIG. 2 is an exploded view of the multi-solenoid linear vibration motor in FIG. 1;

FIG. 3 is an exploded view of a stator and a vibrator of the multi-solenoid linear vibration motor in FIG. 1;

FIG. 4 is a cross-sectional view of the multi-solenoid linear vibration motor taken along line AA in FIG. 1;

FIG. 5 illustrates a distribution of a magnetic pole of the multi-solenoid linear vibration motor;

FIG. 6 is an illustration of a magnetic circuit of the multi-solenoid linear vibration motor;

FIG. 7 is an isometric view of a multi-solenoid linear vibration motor in accordance with a second exemplary embodiment of the present disclosure;

FIG. 8 is an exploded view of the multi-solenoid linear vibration motor in FIG. 7;

FIG. 9 is an exploded view of a stator and a vibrator of the multi-solenoid linear vibration motor in FIG. 7;

FIG. 10 is a cross-sectional view of the multi-solenoid linear vibration motor taken along line BB in FIG. 7;

FIG. 11 illustrates a distribution of a magnetic pole of the multi-solenoid linear vibration motor in FIG. 7;

FIG. 12 illustrates a magnetic circuit of the multi-solenoid linear vibration motor of the second embodiment.

### DETAILED DESCRIPTION OF THE EXEMPLARY EMBODIMENTS

The present disclosure will hereinafter be described in detail with reference to exemplary embodiments. To make the technical problems to be solved, technical solutions and beneficial effects of the present disclosure more apparent, the present disclosure is described in further detail together with the figures and the embodiments. It should be understood the specific embodiments described hereby is only to explain the disclosure, not intended to limit the disclosure.

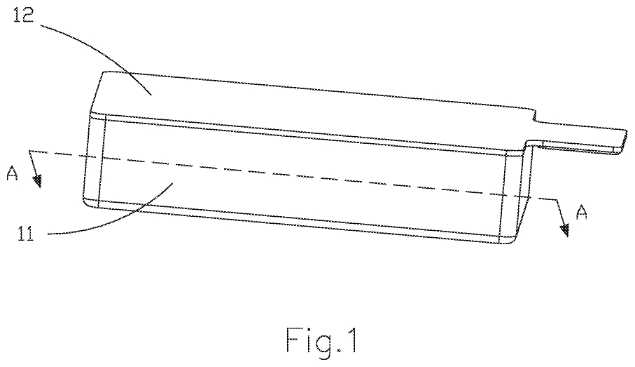

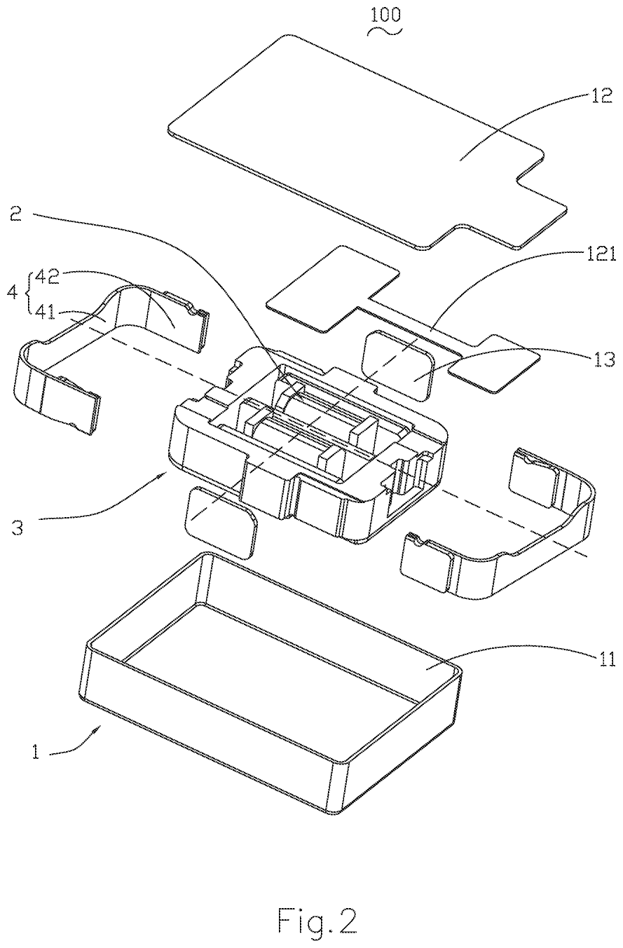

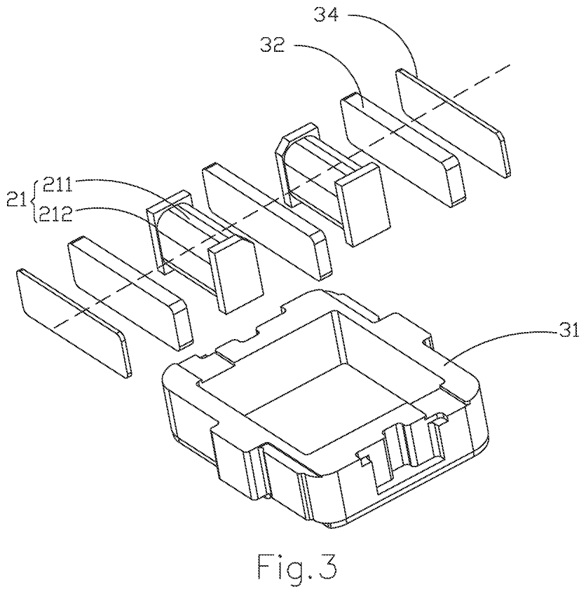

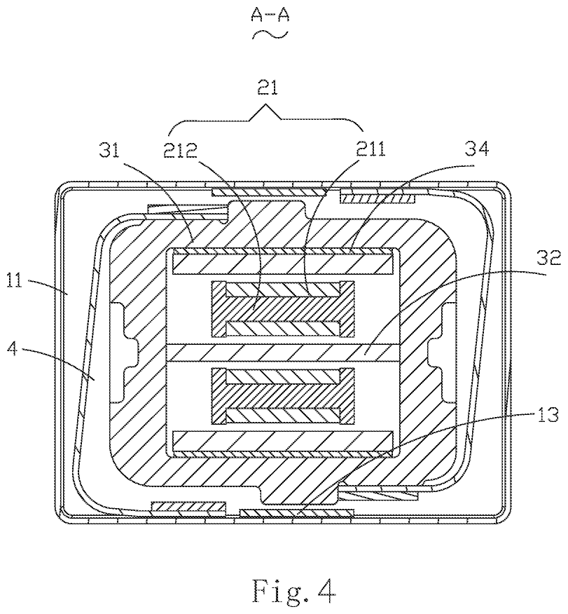

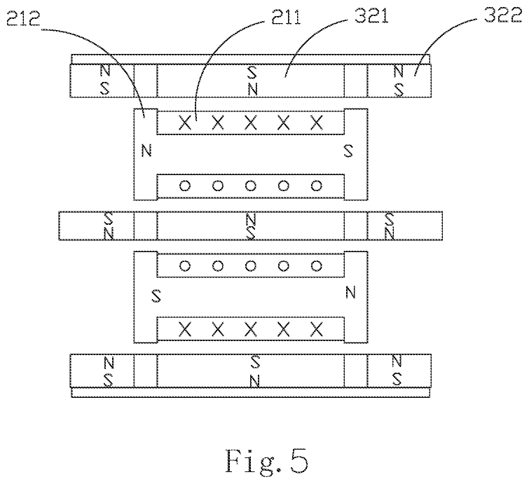

As shown in FIGS. 1-5, a multi-solenoid linear vibration motor 100 in accordance with a first embodiment includes a housing body 1 with an accommodation space, and a stator 2 installed in housing body 1, a vibrator 3 and an elastic connector 4. The housing body 1 includes a housing 11 and a cover plate 12. The cover plate 12 is provided with a flexible circuit board 121 which is electrically connected to the stator 2. The cover plate 12 is buckled with the housing 11 to form a closed cavity. The stator 2, vibrator 3 and elastic connector 4 are all arranged in the cavity. The stator 2 is fixedly installed on the inner wall of the housing 11.

The stator 2 includes N pieces of solenoid assemblies 21 with parallel axes and spaced apart. N is an integer not less than 2. The solenoid assembly 21 comprises voice coil 211 and iron core 212. The solenoid assembly 21 is fixedly installed on the inner wall of the housing 11. When the cover plate 12 is closed, the voice coil 211 and the flexible circuit board 121 are electrically connected. The current direction of voice coil 211 matches the magnetic field arrangement of the system. There is enough space between adjacent solenoid assemblies 21 to facilitate the installation of some components of the vibrator 3.

The vibrator 3 includes N+1 pieces of axial magnet units 32 parallel to the axis of the solenoid assembly 21. The axial magnet unit 32 is arranged on the side of the voice coil 211 of the solenoid assembly 21. The axial magnet unit 32 and the solenoid assembly 21 are alternately arranged at intervals. The axial magnet unit 32 is evenly arranged between adjacent solenoid assemblies 21 and between the solenoid assemblies 21 and the inner wall of the housing body 1.

The length of the axial magnet unit 32 is greater than the length of the solenoid assembly 21. The axial magnet unit 32 includes a central area 321 facing the solenoid assembly 21, and two outer areas 322 located at both ends of the central area 321. The central area 321 is the area where the axial magnet unit 32 and the solenoid assembly 21 overlap in the vertical direction of the axis. The magnetizing direction of the axial magnet unit 32 is perpendicular to the axial direction of the solenoid assembly 21. The polarity of the magnetic pole on the side of the central area 321 close to the solenoid assembly 21 is opposite to the polarity of the magnetic pole on the side of the outer area 322 close to the solenoid assembly 21. The arrangement of the magnetic field follows the principle of forming a closed magnetic circuit. The adjacent axial magnet units 21 are arranged opposite to each other with the same pole. That is, the polarities of the axial magnet units 32 on both sides of the voice coil 211 of the solenoid assembly 21 facing the voice coil 211 are the same. The energization directions of adjacent solenoid assemblies 21 are opposite. The axial magnet unit 32 is an integral multi-polar magnetized magnet or is formed by a combination of multiple split magnets arranged in parallel. The axial magnet unit 32 of this embodiment is multi-polarized on a piece of magnet. It can not only save costs, but also reduce magnetic resistance. Obtain a better magnetic circuit and increase the driving force. Of course, in other embodiments, a plurality of magnets can also be assembled to form an axial magnet unit 32 that meets the polarity requirements of the embodiment. The number of solenoid assembly 21 settings can be adjusted according to actual needs. The preferred number of solenoid assemblies 21 for this embodiment is two. The number of axial magnet unit 32 is three. The axial magnet unit 32 and the solenoid assembly 21 are alternately arranged at intervals.

The preferred vibrator 3 of the embodiment also includes a weight 31, which is a frame structure. The axial magnet unit 32 is fixedly connected to the weight 31. The outermost axial magnet unit 32 of the embodiment is connected to the inner wall of the weight 31 of the frame structure through the pole plate 34. The pole plate 34 is installed on the weight 31. The axial magnet unit 32 can be directly adhered to the surface of the pole plate 34 by glue. The pole plate 34 should have a good magnetic flux rate.

In order to prevent the weight 31 from directly hitting the side wall of the housing body 1 during the vibration process, causing deformation or damage, the embodiment preferably further includes a baffle plate 13. The baffle plate 13 is arranged on the inner wall of the housing body 1. When weight 31 hits housing body 1, it forms a cushioning effect.

The preferred elastic connector 4 of this embodiment includes a substrate 41 and two connection parts 42 symmetrically arranged at the ends of the substrate 41. The connection part 42 and the substrate 41 are bent transitional connections, and the inner contour formed by the elastic connector 4 corresponds to the outer contour of half of the weight 31. A connection part 42 of elastic connector 4 is fixedly connected to weight 31. The other connection part 42 is fixedly connected to the inner wall of the housing body 1. A pair of elastic connectors 4 are symmetrically arranged on opposite sides of the weight 31, and an encircling circle is formed on the outside of the weight 31. The elastic connector 4 suspends the vibrator 3 in the housing body 1. Vibrator 3 moves relative to housing body 1 under the action of driving force.

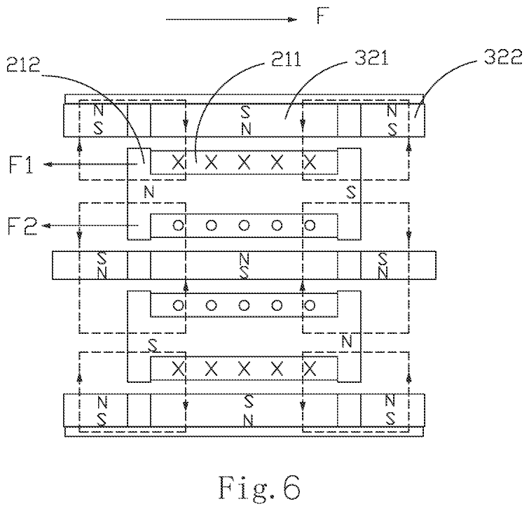

The magnetic circuit structure of embodiment 1 is shown in FIG. 6, and the driving principle of the magnetic circuit is as follows:
1. When the voice coil 211 is energized as shown in FIG. 6, the magnetic field passes through the voice coil 211 vertically, generating a leftward ampere force F2;
2. The two solenoid assemblies will generate a magnetic field inside the solenoid assembly under the action of the current as shown in FIG. 6, thereby polarizing the inner iron core 212. The polarized polarity of the iron core 212 is shown in FIG. 6. Under the action of an external magnetic field, the stator is subjected to an electromagnetic force Fl directed to the left.
3. Under the combined action of the above two forces, the vibrator receives a driving force F that is directed to the right. Therefore, when the voice coil is energized as shown in FIG. 6, the vibrator moves to the right, and vice versa.

In this magnetic circuit structure, the magnet is arranged in an array in the axial direction of the solenoid assembly, which makes full use of the magnetic field and improves the driving force of the magnetic circuit. At the same time, the multi-solenoid assembly structure can also effectively reduce the magnetic saturation caused by the iron core when the current is large.

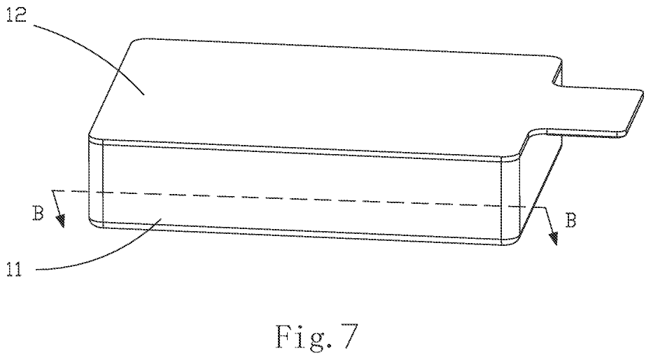

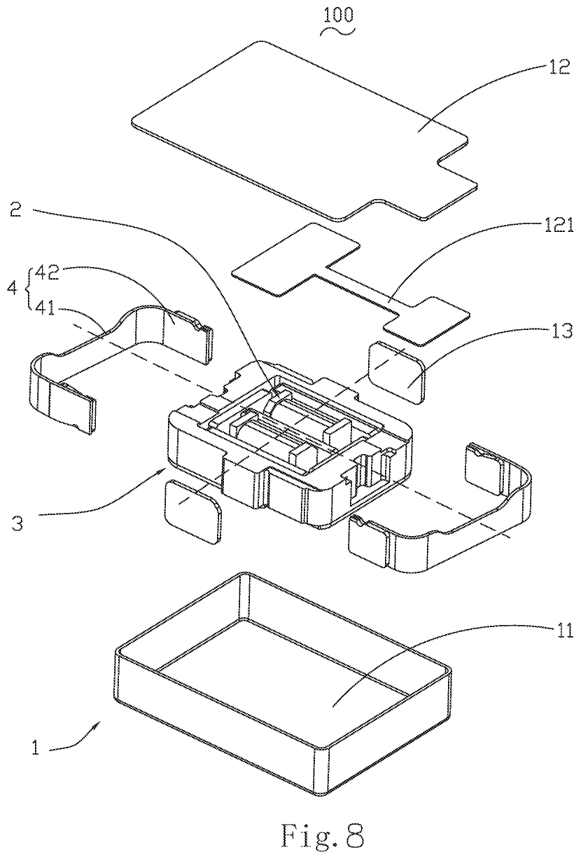

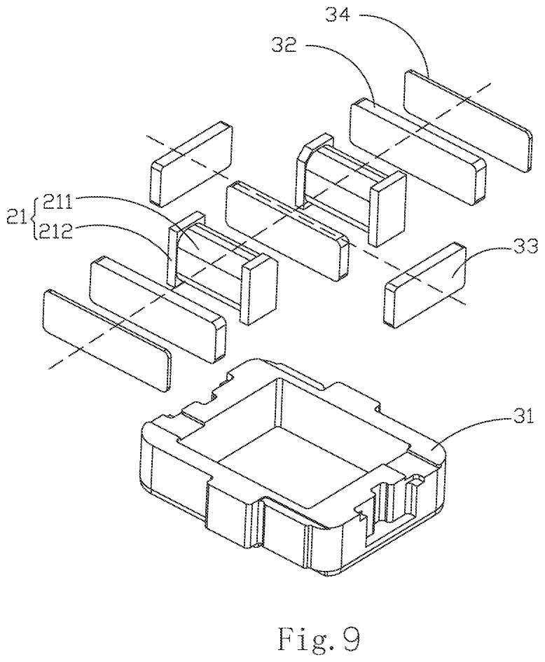

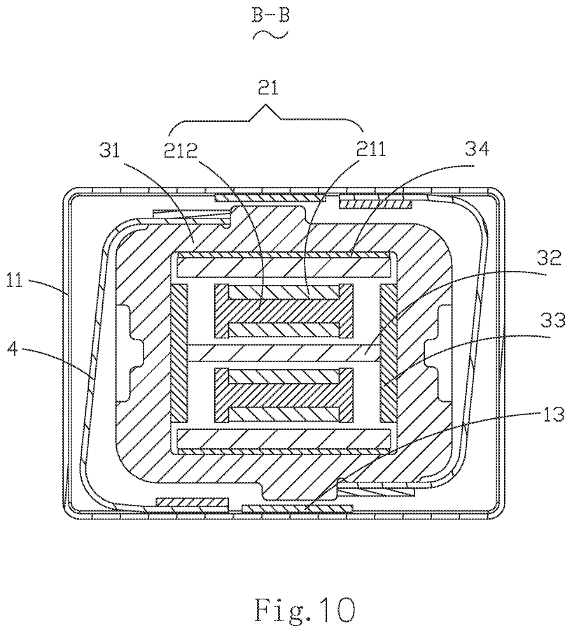

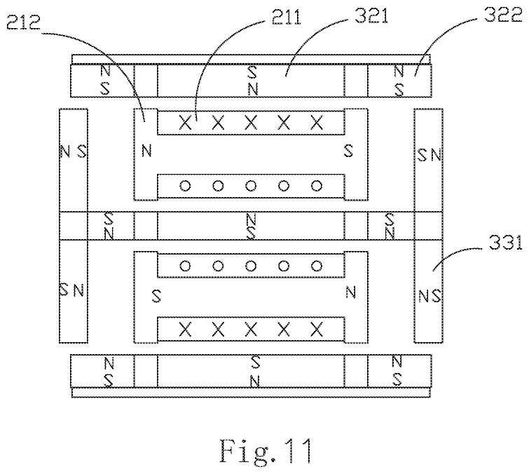

As shown in FIGS. 7-11, in addition to the axial magnet unit 32 set parallel to the axis of the solenoid assembly 21, the vibrator 3 of the second embodiment also includes a pair of end magnet units 33 perpendicular to the axis of the solenoid assembly 21. The end magnet unit 33 includes N pieces of end part areas 331 corresponding to each solenoid assembly 21 respectively. That is, a magnet unit 331 and a solenoid assembly 21 are set correspondingly. The magnetizing direction of the end magnet unit 33 is parallel to the axial direction of the solenoid assembly 21. A pair of end magnet units 33 are arranged at opposite ends of the solenoid assembly 21 with the same poles. The arrangement of the magnetic field follows the principle of forming a closed magnetic circuit. The magnetic pole polarity of the central area 321 of the axial magnet unit 32 facing the adjacent solenoid assembly 21 is opposite to that of the end part area 331 of the end magnet unit 33 facing the solenoid assembly 21. A pair of end magnet units 33 are arranged opposite to each other with the same pole and are respectively arranged at the two ends of the solenoid assembly 21. That is, the magnet units 331 at both ends of the voice coil 211 of each solenoid assembly 21 facing the voice coil 211 have the same magnetic pole polarity, and it is opposite to magnetic pole polarity of the axial magnet unit 32 on both sides of the voice coil 211 facing the voice coil 211. The end magnet unit 33 is an integrated multi-polar magnetized magnet or is formed by a combination of multiple split magnets arranged in parallel. The end magnet unit 33 of this embodiment is arranged with multi-polarity on a piece of magnet. It can not only save costs, but also reduce magnetic resistance. Obtain a better magnetic circuit and increase the driving force. Of course, in other embodiments, multiple magnets can also be assembled to form an end magnet unit 33 that meets the polarity requirements of the embodiment.

The preferred vibrator 3 of the embodiment also includes a weight 31, and a pair of end magnet units 33 are located between the end of the solenoid assembly 21 and the inner wall of the housing body 1. A pair of end magnet unit 33 and weight 31 are fixedly connected. Two ends of the axial magnet unit 32 located between two adjacent solenoid assemblies 21 are respectively fixedly connected to a pair of end magnet units 33. The axial magnet unit 32, the end magnet unit 33 and the weight 31 form an integral structure. In the embodiment, the preferred number of solenoid assemblies 21 is two, and the number of axial magnet units 32 is three. The axial magnet unit 32 and the solenoid assembly 21 are alternately arranged at intervals. A pair of end magnet units 33 are symmetrically arranged at both ends of the solenoid assembly 21. The magnetic circuit structure of the embodiment can make good use of the magnetic circuit. The other connection structure of embodiment 2 is the same as that of embodiment 1.

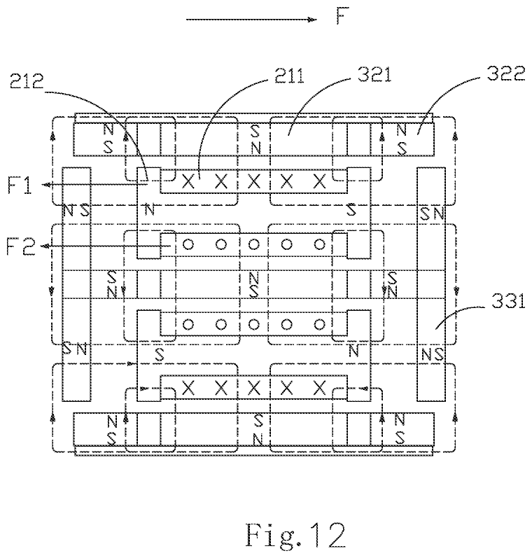

The magnetic circuit structure of embodiment 2 is shown in FIG. 12, and the driving principle of the magnetic circuit is as follows:
1. When the voice coil 211 is energized as shown in FIG. 12, after the magnetic field passes through the voice coil 211 vertically, a leftward ampere force F2 is generated;
2. The two solenoid assemblies will generate a magnetic field inside the solenoid assembly under the action of the current as shown in FIG. 12. As a result, the inner iron core 212 is polarized, and the polarized polarity of the iron core 212 is shown in FIG. 12. Under the action of an external magnetic field, the stator is subjected to an electromagnetic force F1 directed to the left.
3. Under the combined action of the above two forces, the vibrator receives a driving force F that is directed to the right. Therefore, when the voice coil is energized as shown in FIG. 12, the vibrator moves to the right, and vice versa.

In this magnetic circuit structure, magnet is arranged in an array around the solenoid assembly. The magnetic field is fully utilized and the driving force of the magnetic circuit is improved. At the same time, the multi-solenoid assembly structure can also effectively reduce the magnetic saturation caused by the iron core at large currents.

It is to be understood, however, that even though numerous characteristics and advantages of the present exemplary embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms where the appended claims are expressed.

What is claimed is:

1. A multi-solenoid linear vibration motor, comprising:
a housing body with an accommodation space;
s a stator installed in the housing body, comprising N solenoid assemblies with parallel axes and spaced apart from each other, where N is an integer not less than 2;
a vibrator comprising N+1 pieces of axial magnet units parallel to an axis of the solenoid assembly, a length of the axial magnet unit is greater than a length of the solenoid assembly; a magnetizing direction of the axial magnet unit is perpendicular to the axis of the solenoid assembly, the axial magnet unit comprises a central area directly opposite to the solenoid assembly and two outer areas respectively located at two ends of the central area, and a polarity of the magnetic pole on a side of the central area close to the solenoid assembly is opposite to a polarity of the magnetic pole on a side of the outer area close to the solenoid assembly; and
an elastic connector suspending the vibrator in the housing body; wherein
each solenoid assembly locating between two adjacent axial magnet units, each axial magnet unit locating between two adjacent solenoid assembly;
the adjacent axial magnet units are opposite to each other with the same poles facing each other; energization directions of the adjacent solenoid assemblies are opposite.

2. The multi-solenoid linear vibration motor as described in claim 1, wherein the axial magnet unit is a monolithic multi-polar magnetized magnet or is formed by a combination of multiple split magnets arranged in parallel.

3. The multi-solenoid linear vibration motor as described in claim 2, wherein an amount of the solenoid assemblies is two; and an amount of the axial magnet units is three.

4. The multi-solenoid linear vibration motor as described in claiml, wherein, the vibrator further includes a pair of end magnet units perpendicular to the axis of the solenoid assembly; the end magnet unit includes N end part areas respectively corresponding to each of the solenoid assemblies; the magnetizing direction of the end magnet unit is parallel to the axis direction of the solenoid assembly; the polarity of the magnetic pole of the central area of the axial magnet unit facing the adjacent solenoid assembly is opposite to that of the end part area of the end magnet unit facing the solenoid assembly; the pair of end magnet units are arranged opposite to each other with the same pole and are respectively arranged at two ends of the solenoid assembly.

5. The new multi-solenoid linear vibration motor as described in claim 4, wherein, the end magnet unit is an integrated multi-polar magnetized magnet or is formed by a plurality of separate magnets arranged in parallel.

6. The multi-solenoid linear vibration motor as described in claim 5, wherein, both ends of the axial magnet unit located between two adjacent solenoid assemblies are respectively fixedly connected to the pair of end magnet units.

7. The multi-solenoid linear vibration motor as described in claim 5, wherein an amount of the solenoid assembly is two; and an amount of the axial magnet units is three.

8. The multi-solenoid linear vibration motor as described in claim 4, wherein the vibrator further includes a weight; the pair of end magnet units is fixedly connected to the weight.

9. The multi-solenoid linear vibration motor as described in claim 1, wherein the vibrator further includes a weight; an outermost axial magnet unit is connected to the inner wall of the weight through a pole plate.

10. The multi-solenoid linear vibration motor as described in claim 9, wherein the elastic connector includes a substrate, two connection parts symmetrically arranged at ends of the substrate, and a fixed connection between one of the connection parts and the weight; the other connection part connects with the inner wall of the housing body; a pair of the elastic connectors is symmetrically arranged on opposite sides of the weight.
